(19) United States
(12) Patent Application Publication
(10) Pub. No.: US 2025/0359650 A1
(43) Pub. Date: Nov. 27, 2025

(54) Dual head toothbrush

(71) Applicant: Mikel Edgar Lopez, Beltsville, MD (US)

(72) Inventor: Mikel Edgar Lopez, Beltsville, MD (US)

(21) Appl. No.: 18/672,056

(22) Filed: May 23, 2024

(51) Int. Cl. A46B 5/00; A46B 13/02; A61C 17/22

(52) U.S. Cl. CPC A46B 5/0012; A46B 13/02; A61C 17/222; A61C 2204/002

(57) ABSTRACT

The present invention relates to an assembly with a novel design of dual head open and close option toothbrush. The assembly is battery operated, easy to use, provides better output, and is easy to use.

### BACKGROUND

### Field of the Invention

This invention relates to toothbrushes. More particularly, this invention relates to dual head toothbrushes.

### Description of the Related Art

As disclosed in U.S. Pat. Nos. 5,121,520 and 5,499,421 issued to the present inventor, Michael Brice, the disclosures of which are incorporated herein by reference, to effectively clean teeth and gum areas complex maneuvering of a toothbrush is necessary. It is generally acknowledged that the great majority of individuals brush their teeth and gum surfaces primarily in a horizontal and semi-circular manner, even though this particular technique is not deemed to be the best way of cleaning the teeth and gum surfaces. There are two reasons why most individuals resort to this ineffective technique. First, conventional brushing heads are not particularly designed to follow the contours of the teeth and gum surfaces, and as an extension of the human arm do not permit complicated and exact maneuvers to be performed. Second, most brushing takes place in the early morning when one first arises and in the evening just prior to retiring. This is a factor, as demanding complicated procedures for this time of day and night are beyond the tolerance of most individuals. For these reasons, most individuals resort to a simple natural horizontal or semi-circular conventional brushing technique.

Numerous attempts have been made in the past as shown, for example, in U.S. Pat. No. 860,840 to Strassburger, U.S. Pat. No. 3,742,549 to Scopp et al., and U.S. Pat. No. 4,67,360 to Marthaler et al. to improve the design of the toothbrush such as the bristles and/or the head. U.S. Pat. No. 860,840 to Strassburger discloses a toothbrush having two rows of bristles sloped in opposite directions relative to each other, and a central section of bristles arranged parallel to and located between the two outside rows. However, these prior toothbrushes do not simultaneously and/or independently accommodate different contours of the teeth.

In other patents, adjacent head portions of a toothbrush are made to pivot or flex relative to the handle portion so that the bristles are better able to conform to the contours of the teeth and gum surfaces. Such an arrangement is shown in U.S. Pat. No. 928,328 to Carpentier, U.S. Pat. No. 2,266,195 to Hallock, U.S. Pat. No. 3,152,349 to Brennesholtz, U.S. Pat. No. 4,333,199 to Del Rosario, U.S. Pat. No. 4,488,328 to Hyman, U.S. Pat. No. 4,691,405 to Reed, and U.S. Pat. No. 4,776,054 to Rauch. More particularly, U.S. Pat. No. 4,333,199 to Del Rosario and U.S. Pat. No. 4,488,328 to Hyman disclose a toothbrush having a single discreet brushing head that can be pivoted about the handle. The Del Rosario patent, in addition, discloses a brushing head that can rotate about three planes.

U.S. Pat. No. 1,928,328 to Carpentier, U.S. Pat. No. 2,266,195 to Hallock, U.S. Pat. No. 3,152,349 to Brennesholtz and U.S. Pat. No. 4,691,405 to Reed show a toothbrush head capable of flexing or articulating relative to the handle. Specifically, the brushing head comprises a plurality of serially arranged flexing head segments, wherein the segments flex in union or relative to each other.

Finally, U.S. Pat. No. 4,776,054 to Rauch discloses a toothbrush head having three arranged brushing segments, whereby the central segment is aligned with the handle and the two segments on either side are symmetrically arranged relative to the central segment. The bristles on the outer sides of the Rauch patent have narrow, blade-like, contact points which are likely to induce excessive pressure to the gum due to the narrow contact points. In other words, the narrow blade-like bristles inherently place higher excessive concentrated pressure on the gum more so than bristles with a larger contact area.

None of these toothbrushes are directed to overcoming ineffective brushing techniques, or the individual's anatomically limited abilities to effectively clean the curvilinear surfaces of the teeth and provide for gentle stimulation of the varying gum tissues without harm or discomfort for the user, for example, by utilizing side-by-side arranged brushing heads.

In addition, none of these toothbrushes provide for the discreet functioning of one or more brushing heads as separate elements by addressing the force exerted by the user (hereinafter “the X Value”), the resistance/resiliency characteristics of the molecular density of the material used in conjunction with the structural dimensions of the toothbrush (hereinafter “the Y Value”), in concert with the resistance/resiliency of the bristle body as separate functioning elements of the uniform bristle body mass (hereinafter “the Z Value”), as well as the lateral resistance characteristics of the one or more necks (hereinafter “the L Value”).

Moreover, none of these toothbrushes enables the varying of the brushing pressure, in accordance with the proclivity of the user, in order to prevent excessive pressure from being applied to the gums and/or gingival tissue or from injury to the tooth enamel.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The present invention seeks to improve devices for advancement presenting a dual-head toothbrush.

It is the object of the present invention to provide a dual-head toothbrush that opens and closes.

It is a more particular object of the present invention to provide improved in toothbrushes allowing to perform cleaning in an effective manner.

It is also the objective of the invention to provide a dual-headed toothbrush that works with a rechargeable battery.

It is another object of the present invention to provide a dual-headed toothbrush that allows the simultaneous cleaning of two or more tooth surfaces. In t

It is a further object of the present invention to provide an assembly that can accommodate all types of teeth structures.

Thus, it is the objective to provide a new and improved form of toothbrush. Other aspects, advantages and novel features of the present invention will become apparent from the detailed description of the invention when considered in conjunction with the accompanying drawings.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 shows the complete right view of assembly consistent with illustrative embodiments of the invention.

FIG. 2 shows the complete left view of assembly consistent with illustrative embodiments of the invention.

FIG. 3 shows the closed front view of assembly consistent with illustrative embodiments of the invention.

FIG. 4 shows open front view consistent with illustrative embodiments of the invention.

FIG. 5 shows the back view with an open head consistent with illustrative embodiments of the invention.

FIG. 6 shows the back view with a closed head consistent with illustrative embodiments of the invention.

FIG. 7 shows the battery compartment view with a closed head consistent with illustrative embodiments of the invention.

FIG. 8 shows the battery compartment view with an open head consistent with illustrative embodiments of the invention.

FIG. 9 shows the closeup view of brush consistent with illustrative embodiments of the invention.

FIG. 10 shows the open head consistent with illustrative embodiments of the invention.

FIG. 11 shows the close head consistent with illustrative embodiments of the invention.

FIG. 12 shows the complete assembly with the charging panel consistent with illustrative embodiments of the invention.

FIG. 13 shows the back view with the charging panel consistent with illustrative embodiments of the invention.

FIG. 14 shows the perspective use of the toothbrush while in a closed form consistent with illustrative embodiments of the invention.

FIG. 15 shows the perspective use of the toothbrush in an open form consistent with illustrative embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

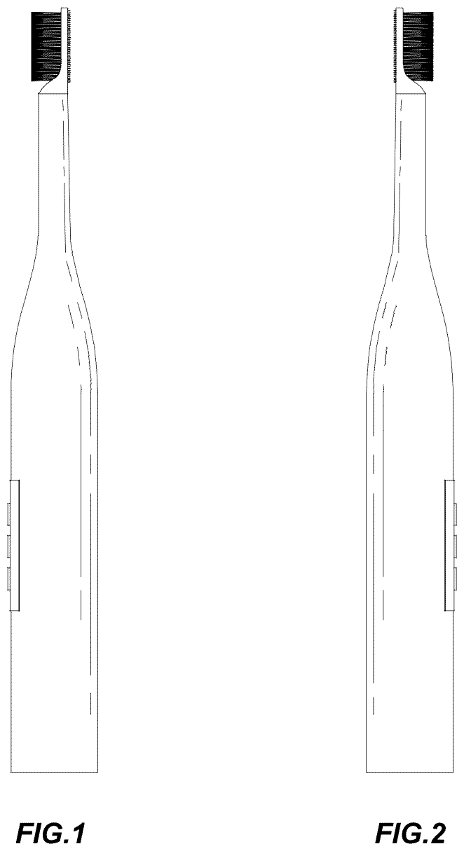

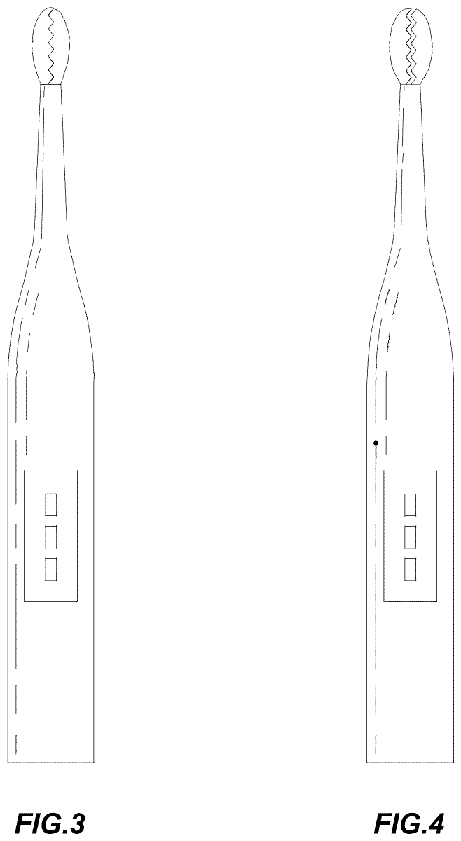

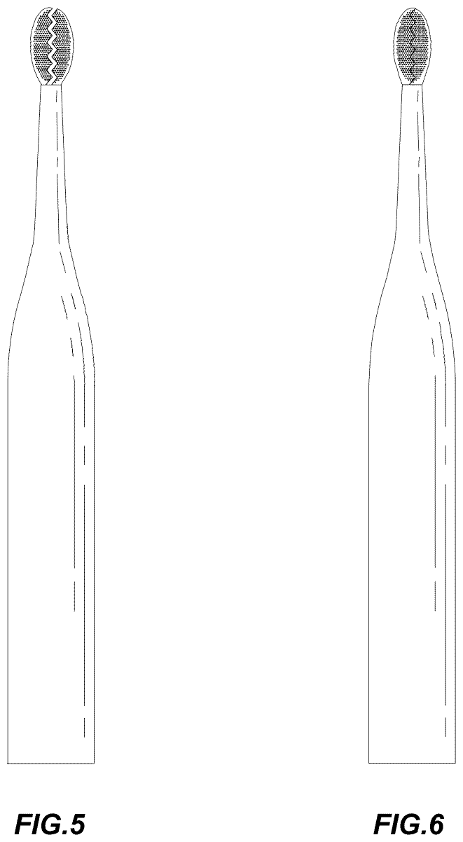

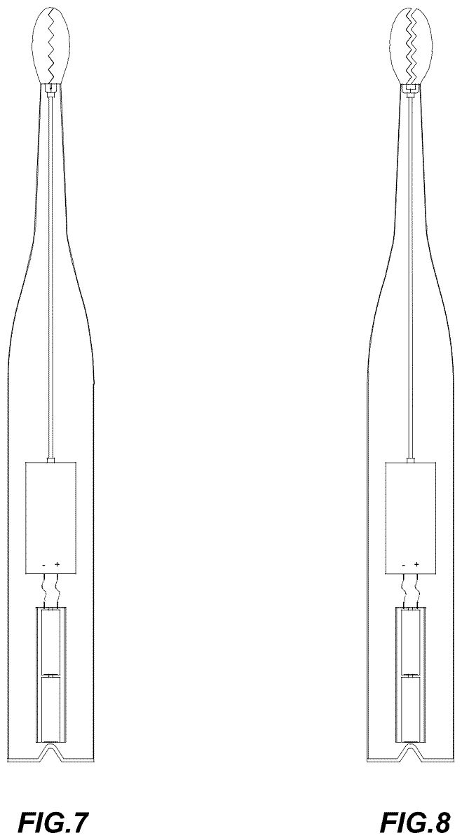

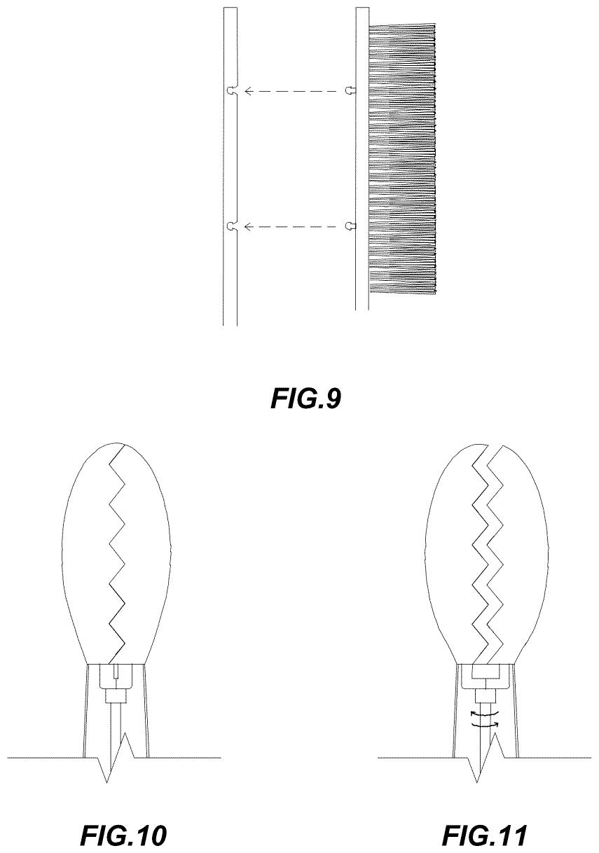

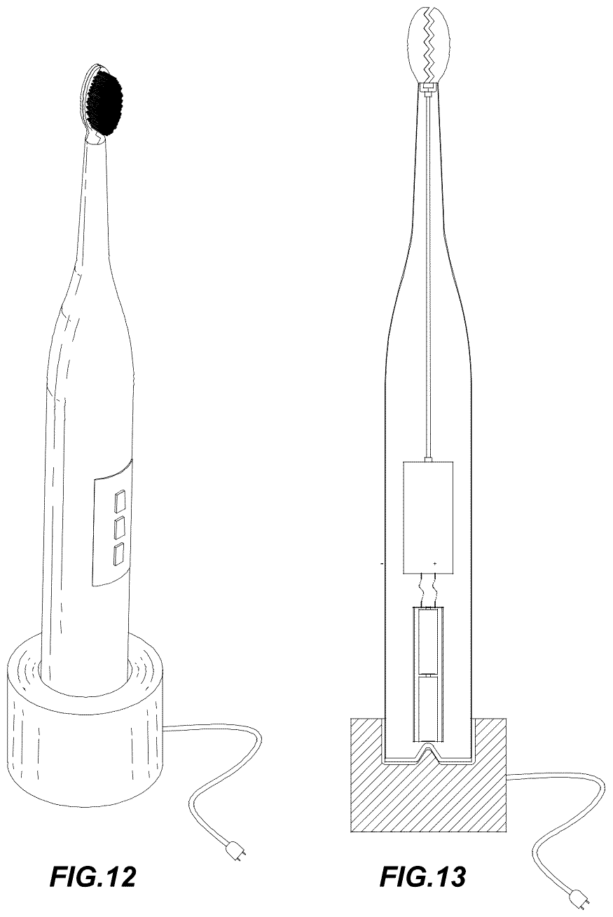

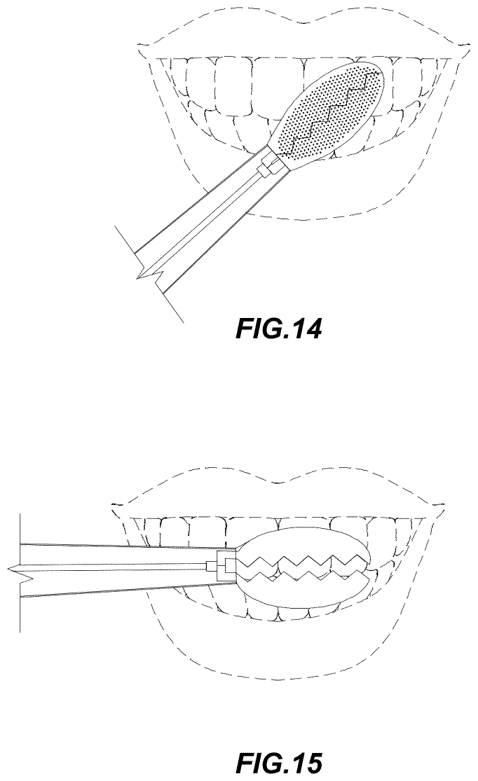

The embodiment of the toothbrush of the present invention is shown in FIG. 1-FIG. 15. Referring now to the drawings, there is shown an electric toothbrush comprised of a handle portion housing an electrically reversible motor operated by means of a switch. The motor may be operated by means of a cord plugged into a regular electrical outlet, by batteries or by a rechargeable cell, as desired.

The motor is provided with a drive rod adapted to connect detachably with a stem for a rotary brush as by means of a spline connection. The brush head preferably has a cylindrical configuration the bristles being arranged in a helix about the tip of the stem.

The brush and stem are supported and substantially enclosed by means of a tubular sleeve. The sleeve serves to enclose the shank of the stem to prevent contact between the rotating stem and the inside of the mouth when using the brush and also to support the elongated stem. The sleeve also serves to enclose an arcuate section of the brush so that only a portion of the brush is exposed for contact with the teeth thus protecting the inside of the cheek during the brushing operation.

The sleeve typically is fabricated from plastic or the like and has sufficient resiliency that the sleeve may be snapped into position in the end of the handle and may be quickly removed by a squeezing-pulling action. Once the sleeve is separated from the handle, the brush may be removed for cleaning or replaced by simply opening the hasp to permit the sleeve halves to be opened. A new brush may be quickly and easily inserted by simply placing the tip in the socket and stem within the shank of the sleeve. The sleeve is then closed, locked and inserted back into the handle.

The brush being fully rotatable and reversible and with opening and closing options of head provides optimum cleaning action regardless of which side of the mouth is being brushed since the direction may be selectively reversed for optimum cleaning action. In practice, it is desired that the brush rotate away rather than into the gums. The sleeve not only encloses all moving parts except the exposed section of the brush but also supports it and permits quick and easy replacement and cleaning.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A power-driven dual-head toothbrush, comprising:
a housing,
a motor mounted in said housing,
an elongated stern detachably connected to said motor and extending outwardly of said housing,
a brush mounted to the outer end of said stem,
and,
a head with open and close options.

2. A dual-head power-driven toothbrush according to claim 1 wherein said brush is operated by a motor.

3. A dual-head power-driven toothbrush according to claim 1 wherein the motor is powered by an external power source such as batteries.

4. A dual-head power-driven toothbrush according to claim 1 wherein said brush assists to achieve better cleaning.
